(19) United States
(12) Patent Application Publication
(10) Pub. No.: US 2010/0215334 A1
(43) Pub. Date: Aug. 26, 2010

(54) REPRODUCING DEVICE AND METHOD, INFORMATION GENERATION DEVICE AND METHOD, DATA STORAGE MEDIUM, DATA STRUCTURE, PROGRAM STORAGE MEDIUM, AND PROGRAM

(75) Inventor: Koji Miyagi, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Minato-ku (JP)

(21) Appl. No.: 12/377,335

(22) PCT Filed: Sep. 28, 2007
(86) PCT No.: PCT/JP07/68950

§ 371 Date: Feb. 12, 2009

(30) Foreign Application Priority Data
Sep. 29, 2006 (JP) 2006-268161

(51) Int. Cl. H04N 5/93; H04N 5/91

(52) U.S. Cl. 386/61; 386/95; 386/124; 386/E05.003

(57) ABSTRACT

The present invention relates to a playing apparatus and method that can easily edit or add meta-information, a program storage medium, and a program. A stream playing unit 16 plays a stream on the basis of a stream file, and additionally outputs playback information of the stream being played. A meta-information-file reading unit 14 reads in a meta-information file of the stream being played. A stream-synchronized reading unit 15 causes the meta-information file to be read in synchronization with the video stream played on the basis of playback information of the video stream being played. An additional-image-information providing unit 12 provides additional image information to the video stream on the basis of the read meta-information file. A combining unit 13 combines the provided additional image information with the video stream played by the playing means. The present invention can be applied to a playing apparatus.

### TECHNICAL FIELD

The present invention relates to playing apparatuses and methods, information generating apparatuses and methods, data storage media, data structures, and programs, and more particularly, to a playing apparatus and method that make it possible to easily edit or add meta-information, an information generating apparatus and method, a data storage medium, a data structure, and a program.

### BACKGROUND ART

Hitherto, in packaged media represented by a DVD (Digital Versatile Disc), in addition to playback of images and audio, which has been already realized in video tapes, it has been made possible to perform settings and select content on a menu screen, perform jump playback by, for example, selecting a chapter, and perform selective playback from a plurality of streams using a multi-angle or the like. In particular, there have been an increasing number of content items in which images to which additional image information such as a special privilege image, a making video, an explanatory video, or a design sketch is added are selectable on a menu screen.

Hitherto, in such packaged medium, additional image information is added and displayed in synchronization with the contents of images and audio. Thus, a stream to which additional image information is added in synchronization with the contents of images and audio and a stream to which no additional image information is added are separately created, and both of the streams are recorded and are alternately played (see Patent Document 1).

Patent Document 1: Japanese Unexamined Patent Application Publication No. 2005-335521

### DISCLOSURE OF INVENTION

### Technical Problem

However, in conventional packaged media, in order to add and display additional image information in synchronization with the contents of images and audio, it has been necessary to separately create the additional image information as a stream of images and audio. In order to enable a viewer to select ON/OFF of additional image information, it has been necessary to prepare two streams having the same contents, one with additional image information and the other without additional image information. Editing work thus takes time.

In addition, due to similar reasons, the limited capacity of a medium may be needlessly occupied.

Further, in order to provide a new additional service, a main-part stream including images and audio must be additionally created again.

As a result, because of the above-described problems, in conventional packaged media, almost no additional image information synchronized with images and audio of a main part has been provided.

The present invention has been made in view of the foregoing circumstances, and more particularly, makes it possible to easily edit or record images and audio serving as additional image information.

### Technical Solution

A playing apparatus of a first aspect of the present invention includes stream playing means for playing an input video stream; meta-information reading means for reading in meta-information of the video stream, the meta-information being a separate file from the video stream played by the stream playing means; stream-synchronized reading means for controlling the meta-information reading means to read in the meta-information in synchronization with the video stream being played by the stream playing means on the basis of playback information of the video stream, the playback information being output from the stream playing means; additional-image-information providing means for providing additional image information to the stream on the basis of the meta-information read by the meta-information reading means under control of the stream-synchronized reading means; and combining means for combining the additional image information provided by the additional-image-information providing means with the video stream played by the playing means.

The playing apparatus may further include output means for outputting the video stream combined with the additional image information, the combining being performed by the combining means. The meta-information may be position information on a display screen at the time the video stream combined with the additional image information and output from the output means is displayed.

The meta-information may include first meta information including first time information and second meta-information including second time information. The stream-synchronized reading means may select the first meta-information or the second meta-information by comparing a playback time of the video stream with the first time information or the second time information.

The meta-information reading means may include one or more meta-information reading means in accordance with a format.

The playing apparatus may further include obtaining means for obtaining the meta-information via a network. The stream-synchronized reading means may read in the meta-information obtained by the obtaining means.

The meta-information may be, in a case where the video stream is a sport program, position information on a playback screen corresponding to playback information of each player playing the sport. The additional-image-information providing means may provide, as additional image information, a zoomed screen of a predetermined player on the basis of position information of the predetermined player in synchronization with a playback timing of the video stream played by the playing means.

Content in the video stream may include a plurality of objects in accordance with a time sequence. The meta-information may be correlation information between the plurality of objects in the content in the video stream which changes in accordance with the time sequence.

The meta-information may be correlation information corresponding to playback information of each character in a case where the video stream is a drama or a movie. The additional-image-information providing means may provide, on the basis of the correlation information corresponding to the playback information of each character, a correlation chart of the characters as additional image information in synchronization with the playback information of the video stream played by the playing means.

In a case where the video stream is a drama or a movie, the meta-information may be correlation information corresponding to playback information of each character and additionally introduction information of the character. The additional-image-information providing means may provide, on the basis of the introduction information of each character, the introduction information of the character as additional image information in synchronization with the playback information of the video stream played by the playing means.

A playing method of the first aspect of the present invention includes a stream playing step of playing an input video stream; a meta-information reading step of reading in meta-information of the video stream, the meta-information being a separate file from the video stream played by processing in the stream playing step; a stream-synchronized reading step of controlling the meta-information reading means to read in the meta-information in synchronization with the video stream being played by processing in the stream playing step on the basis of playback information of the video stream played by processing in the stream playing step; an additional-image-information providing step of providing additional image information to the video stream on the basis of the meta-information read by processing in the meta-information reading step under control of processing in the stream-synchronized reading step; and a combining step of combining the additional image information provided by processing in the additional-image-information providing step with the video stream played by processing in the playing step.

A program of the first aspect of the present invention causes a computer to execute a process including a stream playing step of playing an input video stream; a meta-information reading step of reading in meta-information of the video stream, the meta-information being a separate file from the video stream played by processing in the stream playing step; a stream-synchronized reading step of controlling the meta-information reading means to read in the meta-information in synchronization with the video stream being played by processing in the stream playing step on the basis of playback information of the video stream played by processing in the stream playing step; an additional-image-information providing step of providing additional image information to the video stream on the basis of the meta-information read by processing in the meta-information reading step under control of processing in the stream-synchronized reading step; and a combining step of combining the additional image information provided by processing in the additional-image-information providing step with the video stream played by processing in the playing step.

A program storage medium of the first aspect of the present invention stores the program according to claim 9.

A data storage medium of a second aspect of the present invention is a recording medium recording a video stream including time information at which playback should be performed by a playing apparatus. The data storage medium stores, as separate files from the video stream, first meta-information corresponding to the video stream displayed at a first time position, the first meta-information including time information corresponding to the first time position, the first time position being included in a time axis of the time information, and second meta-information corresponding to the video stream displayed at a second time position, the second meta-information including time information corresponding to the second time position, the second time position being included in the time axis of the time information.

A data structure of a third aspect of the present invention is a data structure of a meta-information file to be played together with a video stream including time information at which playback should be performed by a playing apparatus, the meta-information file being recorded in a recording medium or distributed via a network. The data structure includes first meta-information corresponding to the video stream displayed at a first time position, the first meta-information including time information corresponding to the first time position, the first time position being included in a time axis of the time information; and second meta-information corresponding to the video stream displayed at a second time position, the second meta-information including time information corresponding to the second time position, the second time position being included in the time axis of the time information.

The first meta-information and the second meta-information may be separate files independent of each other.

An information generating apparatus of a fourth aspect of the present invention includes time-information obtaining means for obtaining time information corresponding to a time position, the time position being included in a time axis of the time information of a video stream including the time information at which playback should be performed by a playing apparatus; meta-information obtaining means for obtaining meta-information corresponding to the displayed video stream; and storage means for associating at least one item of the time information with the meta-information and storing the associated information as a meta-information file.

The information generating apparatus may further include converting means for converting a format type of the meta-information file.

An information generating method of the fourth aspect of the present invention includes a time-information obtaining step of obtaining time information corresponding to a time position, the time position being included in a time axis of the time information of a video stream including the time information at which playback should be performed by a playing apparatus; a meta-information obtaining step of obtaining meta-information corresponding to the displayed video stream; and a storage step of associating at least one item of the time information with the meta-information and storing the associated information as a meta-information file.

A program of the fourth aspect of the present invention causes a computer to execute a process including a time-information obtaining step of obtaining time information corresponding to a time position, the time position being included in a time axis of the time information of a video stream including the time information at which playback should be performed by a playing apparatus; a meta-information obtaining step of obtaining meta-information corresponding to the displayed video stream; and a storage step of associating at least one item of the time information with the meta-information and storing the associated information as a meta-information file.

A program storage medium of the fourth aspect of the present invention stores the program according to claim 17.

In the playing apparatus and method and the program of the first aspect of the present invention, an input video stream is played; meta-information of the played stream is read; control is performed to read in the meta-information in synchronization with the played stream on the basis of output playback information of the video stream; on the basis of the read meta-information, additional image information is provided to the video stream; and the provided additional image information is combined with the played stream.

In the data storage medium of the second aspect of the present invention, as separate files from a video stream, first meta-information corresponding to the video stream displayed at a first time position, the first meta-information including time information corresponding to the first time position, the first time position being included in a time axis of the time information, and second meta-information corresponding to the video stream displayed at a second time position, the second meta-information including time information corresponding to the second time position, the second time position being included in the time axis of the time information, are stored.

In the data structure of the third aspect of the present invention, first meta-information corresponding to a video stream displayed at a first time position, the first meta-information including time information corresponding to the first time position, the first time position being included in a time axis of the time information of the video stream including the time information at which playback should be performed by a playing apparatus, and second meta-information corresponding to the video stream displayed at a second time position, the second meta-information including time information corresponding to the second time position, the second time position being included in the time axis of the time information, are included.

In the information generating apparatus and method and the program of the fourth aspect of the present invention, time information corresponding to a time position is obtained, the time position being included in a time axis of the time information of a video stream including the time information at which playback should be performed by a playing apparatus; meta-information corresponding to the displayed video stream is obtained; and a meta-information file storing at least one item of the time information associated with the meta-information is generated.

The playing apparatus and the information generating apparatus of the present invention may be independent apparatuses or may be blocks that perform a playing process and an information generating process, respectively.

### ADVANTAGEOUS EFFECTS

According to the present invention, meta-information can be easily edited or added.

### BRIEF DESCRIPTION OF DRAWINGS

FIG. 1 is a diagram illustrating a block diagram showing a structure example of a playing apparatus to which the present invention is applied.

FIG. 2 is a flowchart illustrating an additional-image-information providing process performed by the playing apparatus in FIG. 1.

FIG. 3 is a flowchart illustrating an additional-image-information generating process performed by the playing apparatus in FIG. 1.

FIG. 4 is a diagram illustrating a meta-information file created by the playing apparatus in FIG. 1.

FIG. 5 is a diagram illustrating an additional-image-information providing process performed by the playing apparatus in FIG. 1.

FIG. 6 is a diagram illustrating a block diagram showing another structure example of the playing apparatus.

FIG. 7 is a flowchart illustrating an additional-image-information generating process performed by the playing apparatus in FIG. 6.

FIG. 8 is a diagram illustrating a meta-information file created by the playing apparatus in FIG. 6.

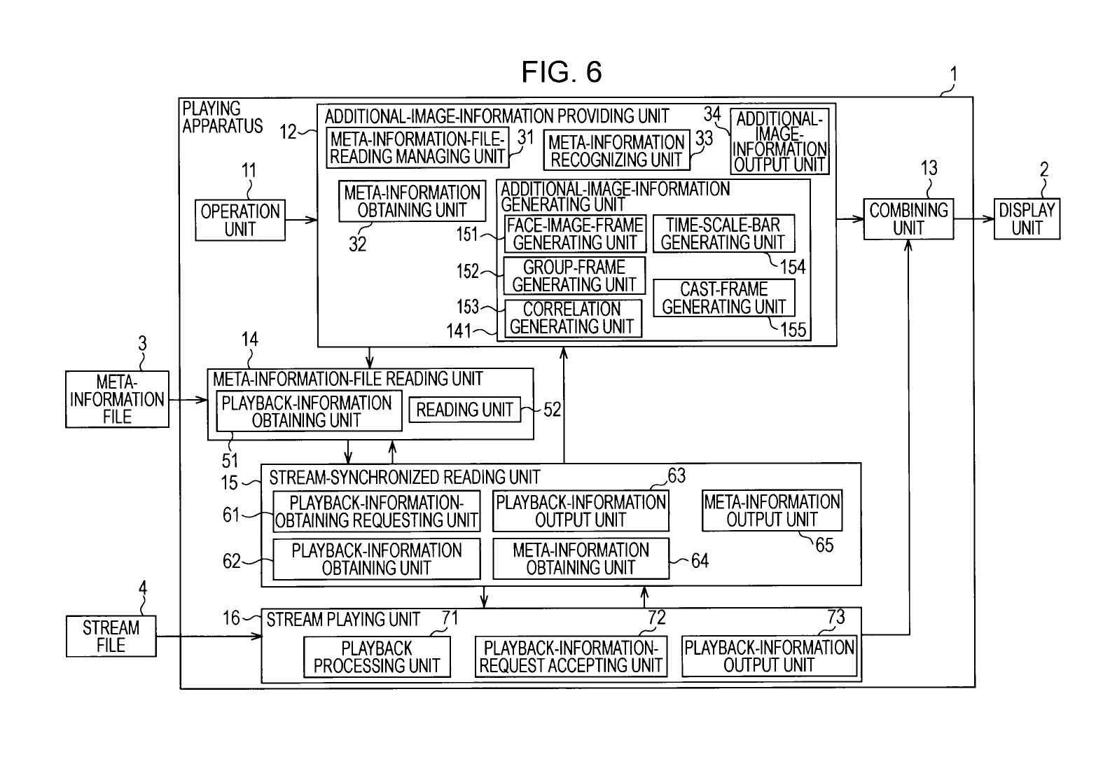

FIG. 6 is a diagram illustrating an additional-image-information generating process performed by the playing apparatus in FIG. 6.

FIG. 10 is a diagram illustrating an additional-image-information generating process performed by the playing apparatus in FIG. 6.

FIG. 11 is a diagram illustrating an additional-image-information generating process performed by the playing apparatus in FIG. 6.

FIG. 12 is a diagram illustrating a block diagram showing yet another structure example of the playing apparatus.

FIG. 13 is a diagram illustrating a block diagram showing a structure example of a meta-information-file generating apparatus.

FIG. 14 is a flowchart illustrating a meta-information-file generating process performed by the meta-information-file generating apparatus in FIG. 13.

FIG. 15 is a diagram illustrating a structure example of a personal computer.

### EXPLANATION OF REFERENCE NUMERALS

1 playing apparatus, 2 display unit, 3 meta-information file, 4 stream file, 11 operation unit, 12 additional-image-information providing unit, 13 combining unit, 14 meta-information-file reading unit, 15 stream-synchronized reading unit, 16 stream playing unit

### BEST MODES FOR CARRYING OUT THE INVENTION

Hereinafter, embodiments of the present invention will be described. An example of the correspondence between the invention described in this specification and an embodiment of the invention is discussed below. This description is intended to assure that an embodiment supporting the invention described in this specification is described in this specification. Thus, even if an embodiment described in the embodiments of the invention is not described as relating to the invention, that does not necessarily mean that the embodiment does not relate to that invention. Conversely, even if an embodiment is described herein as relating to the invention, that does not necessarily mean that the embodiment does not relate to inventions other than that invention.

Further, this description should not be construed that the entirety of the invention described in this specification is described.

In other words, this description does not preclude the existence of the invention described in this specification but not claimed in this application, that is, does not preclude the existence of the invention that is claimed by a divisional application or that appears and is added by amendment in the future.

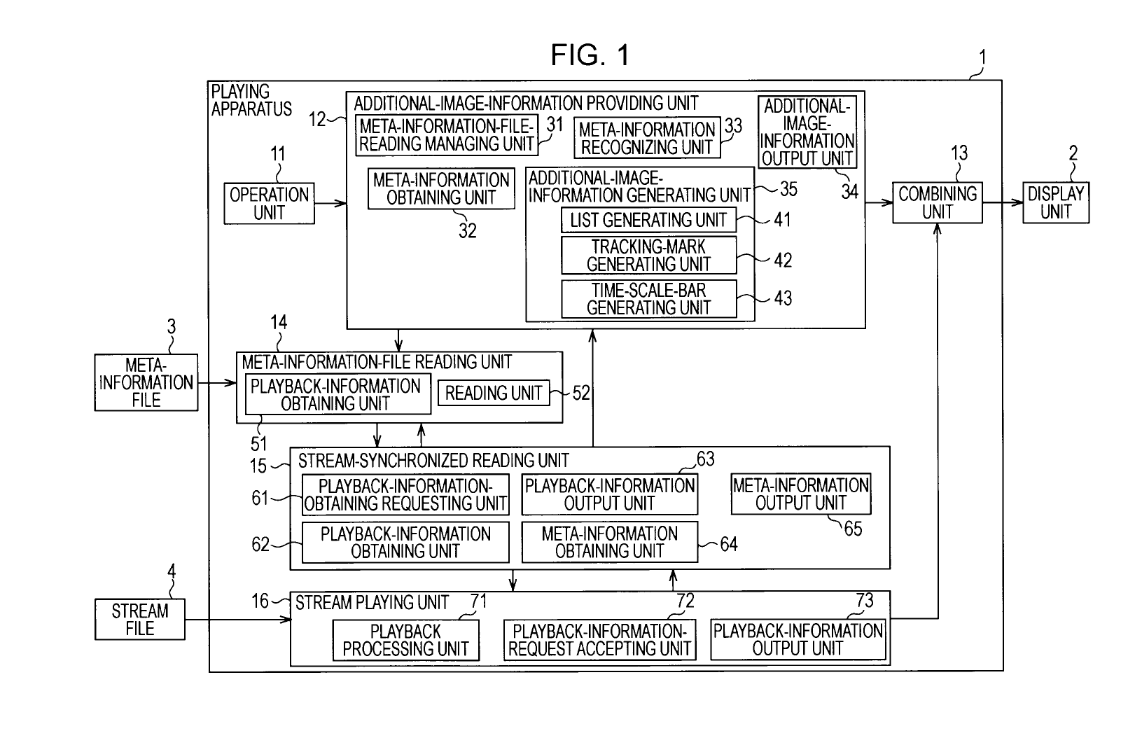

That is, a playing apparatus of a first aspect of the present invention includes stream playing means (e.g., a stream playing unit 16 in FIG. 1) for playing an input video stream; meta-information reading means (e.g., a meta-information-file reading unit 14 in FIG. 1) for reading in meta-information of the video stream, the meta-information being a separate file from the video stream played by the stream playing means; stream-synchronized reading means (e.g., a stream-synchronized reading unit 15 in FIG. 1) for controlling the meta-information reading means to read in the meta-information in synchronization with the video stream being played by the stream playing means on the basis of playback information of the video stream played by the stream playing means; additional-image-information providing means (e.g., an additional-image-information providing unit 12 in FIG. 1) for providing additional image information to the video stream on the basis of the meta-information read by the meta-information reading means under control of the stream-synchronized reading means; and combining means (e.g., a combining unit 13 in FIG. 1) for combining the additional image information provided by the additional-image-information providing means with the stream played by the playing means.

The playing apparatus may further include output means (e.g., a display unit 2 in FIG. 1) for outputting the video stream combined with the additional image information, the combining being performed by the combining means (e.g., the combining unit 13 in FIG. 1). The meta-information may be position information on a display screen at the time the video stream combined with the additional image information and output from the output means is displayed.

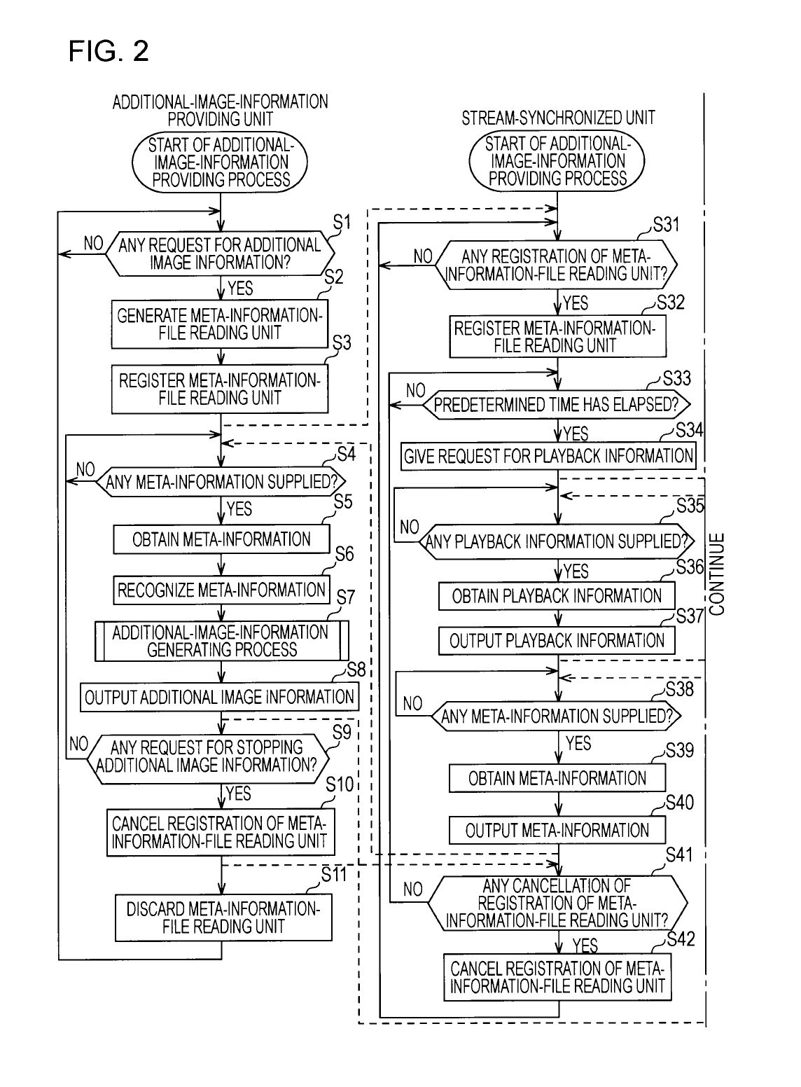

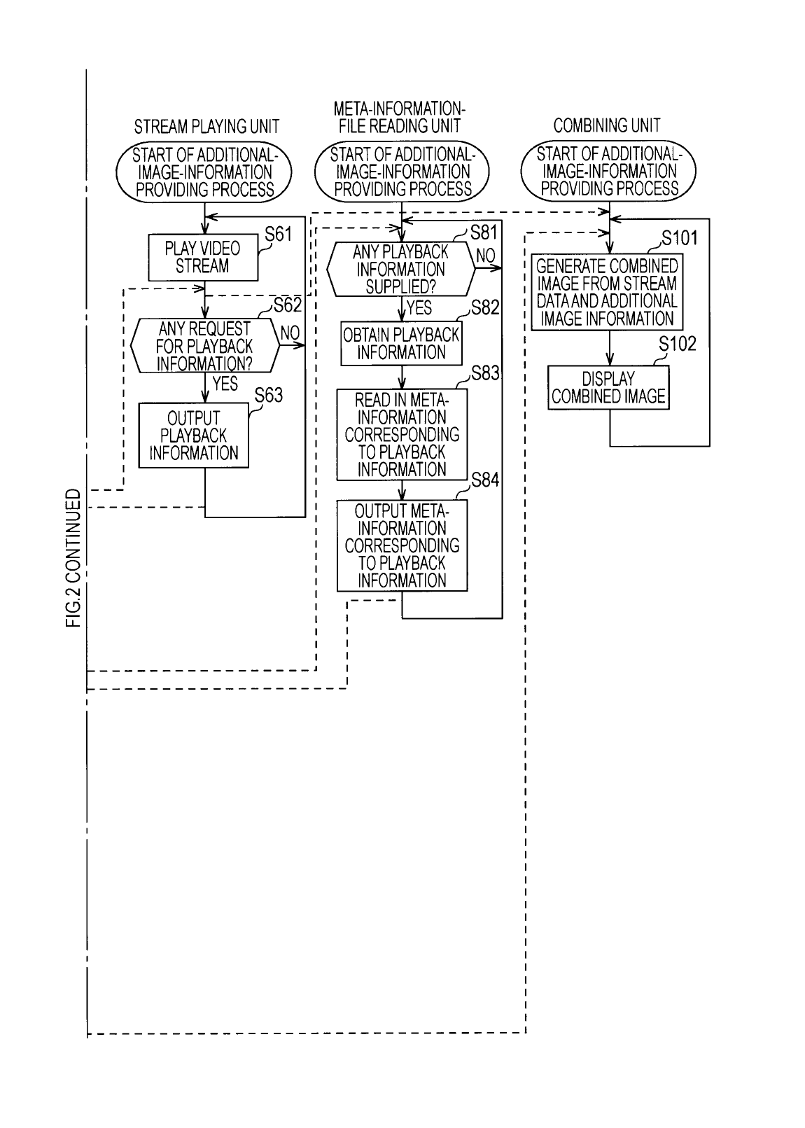

A playing method and a program of the first aspect of the present invention include a stream playing step (e.g., steps S61 and S63 in FIG. 2) of playing an input video stream; a meta-information reading step (e.g., step S83 in FIG. 2) of reading in meta-information of the video stream, the meta-information being a separate file from the video stream played by processing in the stream playing step; a stream-synchronized reading step (e.g., step S39 in FIG. 2) of controlling the meta-information reading means to read in the meta-information in synchronization with the video stream being played by processing in the stream playing step on the basis of playback information of the video stream played by processing in the stream playing step; an additional-image-information providing step (e.g., step S10 in FIG. 2) of providing additional image information to the video stream on the basis of the meta-information read by processing in the meta-information reading step under control of processing in the stream-synchronized reading step; and a combining step (e.g., step S101 in FIG. 2) of combining the additional image information provided by processing in the additional-image-information providing step with the video stream played by processing in the playing step.

An information generating apparatus of a fourth aspect of the present invention includes time-information obtaining means (e.g., a time-information obtaining unit 112 in FIG. 13) for obtaining time information corresponding to a time position, the time position being included in a time axis of the time information of a video stream including the time information at which playback should be performed by a playing apparatus; meta-information obtaining means (e.g., a meta-information obtaining unit 113 in FIG. 13) for obtaining meta-information corresponding to the displayed video stream; and storage means (e.g., a storage unit 114 in FIG. 13) for associating at least one item of the time information with the meta-information and storing the associated information as a meta-information file.

The information generating apparatus may further include converting means for converting a format type of the meta-information file.

An information generating method and a program of the fourth aspect of the present invention include a time-information obtaining step (e.g., step S192 in FIG. 14) of obtaining time information corresponding to a time position, the time position being included in a time axis of the time information of a video stream including the time information at which playback should be performed by a playing apparatus; a meta-information obtaining step (e.g., step S194 in FIG. 14) of obtaining meta-information corresponding to the displayed video stream; and a storage step (e.g., step S195 in FIG. 14) of associating at least one item of the time information with the meta-information and storing the associated information as a meta-information file.

FIG. 1 shows a structure of an embodiment of a playing apparatus to which the present invention is applied. Note that, although a playing apparatus 1 in FIG. 1 illustrates an example configured with software, the playing apparatus 1 may be configured with hardware with similar functions.

The playing apparatus 1 generates additional image information on the basis of a meta-information file 3, combines the additional image information with a video stream played on the basis of a stream file 4, and displays the combined image on a display unit 2.

An operation unit 11 is configured with a keyboard, a mouse, a button, or the like. The operation unit 11 is operated when a user enters, for example, ON or OFF of an additional-image-information providing unit 12, generates an operation signal in accordance with the contents of the operation, and outputs the operation signal to the additional-image-information providing unit 12.

The additional-image-information providing unit 12 generates additional image information on the basis of meta-information supplied from a stream-synchronized reading unit 15 and outputs the additional image information to a combining unit 13. Here, additional image information is information added as an image or the like at the time of playing content recorded in the stream file 4. More specifically, for example, when a video stream played from the stream file 4 is a soccer game, additional image information is, for example, a tracking mark added on a screen to a predetermined player on the basis of meta-information including time-based position information of each player. Note that, although the following description assumes the case where additional image information is a tracking mark added to a predetermined player, the video stream and additional image information are not limited thereto, and may be a stream file from which other content is played and other additional image information.

When a meta-information-file reading unit 14 obtains playback information, which is supplied from the stream-synchronized reading unit 15, of a video stream played by a stream playing unit 16, the meta-information-file reading unit 14 reads in meta-information at a corresponding timing from the meta-information file 3 on the basis of the playback information and supplies the meta-information to the stream-synchronized reading unit 15.

When the stream-synchronized reading unit 15 obtains playback information showing a playback time and a playback frame of the currently played video stream by giving a request for playback information to the stream playing unit 16, the stream-synchronized reading unit 15 supplies the playback information to the meta-information-file reading unit 14. Further, the stream-synchronized reading unit 15 obtains meta-information supplied from the meta-information-file reading unit 14 in accordance with the supplied playback information and supplies the meta-information to the additional-image-information providing unit 12.

The stream playing unit 16 reads in information in the stream file 4, sequentially plays video streams, and outputs the video streams as images to the combining unit 13. At the same time, when a request for playback information is given from the stream-synchronized reading unit 15, the stream playing unit 16 supplies the current playback information to the stream-synchronized reading unit 15.

The combining unit 13 generates an image by combining an image of a video stream played by the stream playing unit 16 and additional image information supplied from the additional-image-information providing unit 12 and displays the image on the display unit 2 including an LCD (Liquid Crystal Display), a CRT (Cathode Ray Tube), or the like.

The additional-image-information providing unit 12 is configured with a meta-information-file-reading managing unit 31, a meta-information obtaining unit 32, a meta-information recognizing unit 33, an additional-image-information output unit 34, and an additional-image-information generating unit 35.

When it is selected to combine additional image information with a stream-played image in accordance with an operation signal from the operation unit 11, that is, when providing of additional image information is set to ON, the meta-information-file-reading managing unit 31 registers the meta-information-file reading unit 14 in the stream-synchronized reading unit 15. Additionally, when it is selected to end displaying of the video stream combined with the additional image information, that is, when providing of the additional image information is set to OFF, the meta-information-file-reading managing unit 31 cancels the registration of the meta-information-file reading unit 14 in the stream-synchronized reading unit 15. That is, when the meta-information-file reading unit 14 exists as software, if providing of additional image information is set to OFF, the meta-information-file reading unit 14 does not exist. Only when providing of additional image information is set to ON, the meta-information-file reading unit 14 is generated by the meta-information-file-reading managing unit 31 and is registered in the stream-synchronized reading unit 15. Note, however, that the meta-information-file-reading managing unit 31 may be hardware; hereinafter a block diagram is constructed regarding that the meta-information-file-reading managing unit 31 exists at all times.

The meta-information obtaining unit 32 obtains meta-information supplied from the stream-synchronized reading unit 15 and supplies the meta-information to the meta-information recognizing unit 33. The meta-information recognizing unit 33 recognizes the supplied meta-information and supplies the recognition result to the additional-image-information generating unit 35.

On the basis of the recognition result of the meta-information, the additional-image-information generating unit 35 generates additional image information and supplies the generated additional image information to the additional-image-information output unit 34. More specifically, the additional-image-information generating unit 35 controls a list generating unit 41, a tracking-mark generating unit 42, and a time-scale-bar generating unit 43 and, on the basis of the recognition result of the meta-information, generates images of a list of players, a tracking mark of a predetermined player, and a time scale bar as additional image information, and supplies the additional image information to the additional-image-information output unit 34.

The additional-image-information output unit 34 outputs the additional image information generated by the additional-image-information generating unit 35 to the combining unit 13. On this occasion, the additional-image-information output unit 34 outputs the additional image information to the combining unit 13 while taking into consideration a processing time from a point at which the playback information is obtained to outputting of the additional image information. That is, the meta-information-file reading unit 14 takes into consideration the processing time in the additional-image-information providing unit 12 and reads in, for example, meta-information of a few frames ahead of the video stream currently being played by the stream playing unit 16. Therefore, the additional-image-information output unit 34 supplies the additional image information to the combining unit 13 at a timing at which the video stream corresponding to a playback position of the obtained meta-information is played by the stream playing unit 16.

A playback-information obtaining unit 51 in the meta-information-file reading unit 14 obtains playback information supplied from the stream-synchronized reading unit 15 and supplies the obtained playback information to a reading unit 52. The reading unit 52 accesses the meta-information file 3, takes into consideration the processing time in the additional-image-information providing unit 12 on the basis of the supplied playback information, reads in meta-information at a timing that is a few frames ahead of the current playback time, and supplies the meta-information to the stream-synchronized reading unit 15.

When the meta-information-file reading unit 14 is registered by the meta-information-file-reading managing unit 31, the stream-synchronized reading unit 15 controls a playback-information-obtaining requesting unit 61 at predetermined time intervals to give a request for playback information to the stream playing unit 16.

In response to the request from the playback-information-obtaining requesting unit 61, a playback-information obtaining unit 62 obtains playback information supplied from the stream playing unit 16 and supplies the playback information to a playback-information output unit 63. The playback-information output unit 63 supplies the playback information supplied from the playback-information obtaining unit 62 to the meta-information-file reading unit 14.

A meta-information obtaining unit 64 obtains meta-information supplied from the meta-information-file reading unit 14 and supplies the meta-information to a meta-information output unit 65. The meta-information output unit 65 supplies the supplied meta-information to the additional-image-information providing unit 12.

A playback processing unit 71 in the stream playing unit 16 accesses the stream file 4, plays a video stream, supplies the video stream to the combining unit 13, and additionally supplies playback information to a playback-information output unit 73. A playback-information-request accepting unit 72 accepts a request for obtaining playback information, which is from the playback-information-obtaining requesting unit 61 in the stream-synchronized reading unit 15, and activates the playback-information output unit 73 on the basis of the request. When the playback-information output unit 73 is notified by the playback-information-request accepting unit 72 of the fact that there has been a request for obtaining playback information, the playback-information output unit 73 outputs playback information supplied from the playback processing unit 71 to the stream-synchronized reading unit 15.

Next, with reference to the flowchart in FIG. 2, an additional-image-information providing process will be described.

In step S1, the meta-information-file-reading managing unit 31 determines whether or not the operation unit 11 has been operated and a request for providing additional image information has been given. The meta-information-file-reading managing unit 31 repeats similar processing until a request is given. When, in step S1, for example, the operation unit 11 has been operated and a request for providing additional image information has been given, that is, when a request for turning ON the operation of the additional-image-information providing unit 12 has been given, in step S2, the meta-information-file-reading managing unit 31 generates the meta-information-file reading unit 14.

In step S3, the meta-information-file-reading managing unit 31 requests the stream-synchronized reading unit 15 to register the generated meta-information-file reading unit 14.

In step S31, the stream-synchronized reading unit 15 determines whether or not a request for registering the meta-information-file reading unit 14 has been given. The stream-synchronized reading unit 15 repeats this processing until a request for registration is given.

When, in step S31, a request for registering the meta-information-file reading unit 14 has been given by, for example, the processing in step S3, in step S32, the stream-synchronized reading unit 15 registers the meta-information-file reading unit 14 which has been requested to be registered.

Note that the processing in steps S2, S3, S31, and S32 (including corresponding steps S10, S11, S41, and S42) is the processing in the case where the meta-information-file reading unit 14 is configured with software. When the meta-information-file reading unit 14 is configured with hardware, the processing is unnecessary processing. Therefore, when the meta-information-file reading unit 14 configured with hardware is used, the processing in steps S2, S3, S31, and S32 (including corresponding steps S10, S11, S41, and S42) is skipped.

In step S33, the playback-information-obtaining requesting unit 61 determines whether or not a predetermined time has elapsed. The playback-information-obtaining requesting unit 61 repeats the processing until the predetermined time has elapsed. When it is determined in step S33 that the predetermined time has elapsed, in step S34, the playback-information-obtaining requesting unit 61 requests the stream playing unit 16 to obtain playback information.

In step S61, the playback processing unit 71 in the stream playing unit 16 reads out the stream file 4, sequentially plays images including audio in accordance with a predetermined procedure, outputs the images including audio to the combining unit 13, and additionally supplies the current playback information to the playback-information output unit 73.

In step S62, the playback-information-request accepting unit 72 determines whether or not there has been a request for obtaining playback information. When it is determined that there has been no request for obtaining playback information, the process returns to step S61. That is, unless there is a request for playback information, images and the like including audio are only simply played as a video stream from a stream file in a continuous manner.

When, in step S62, a request for obtaining playback information has been given by, for example, the processing in step S34, in step S63, the playback-information-request accepting unit 72 controls the playback-information output unit 73 to output playback information supplied from the playback processing unit 71 to the stream-synchronized reading unit 15.

In step S35, the playback-information obtaining unit 62 determines whether or not playback information has been output. The playback-information obtaining unit 62 repeats similar processing until playback information has been output. When, in step S35, playback information has been output by, for example, the processing in step S63, in step S36, the playback-information obtaining unit 62 obtains the output playback information and supplies the obtained playback information to the playback-information output unit 63.

In step S37, the playback-information output unit 63 outputs the supplied playback information to the meta-information-file reading unit 14.

In step S81, the playback-information obtaining unit 51 determines whether or not playback information has been supplied from the stream-synchronized reading unit 15. The playback-information obtaining unit 51 repeats similar processing until playback information has been output. When, in step S81, playback information has been output by, for example, the processing in step S37, it is determined that playback information has been supplied. In step S82, the playback-information obtaining unit 51 obtains the supplied playback information and supplies the obtained playback information to the reading unit 52.

In step S83, the reading unit 52 accesses the meta-information file 3 and, on the basis of the supplied playback information, reads in meta-information corresponding to the playback position of the video stream.

In step S84, the reading unit 52 outputs the read meta-information to the stream-synchronized reading unit 15.

In step S38, the meta-information obtaining unit 64 determines whether or not meta-information has been output. The meta-information obtaining unit 64 repeats the processing until meta-information has been output. When, in step S38, meta-information has been output by, for example, the processing in step S84, in step S39, the meta-information obtaining unit 64 obtains the transmitted meta-information and additionally supplies the obtained meta-information to the meta-information output unit 65.

In step S40, the meta-information output unit 65 outputs the supplied meta-information to the additional-image-information providing unit 12.

In step S4, the meta-information obtaining unit 32 determines whether or not meta-information has been supplied from the stream-synchronized reading unit 15. The meta-information obtaining unit 32 repeats the processing until meta-information has been supplied. When, in step S4, meta-information has been output by, for example, the processing in step S40, in step S5, the meta-information obtaining unit 32 obtains the supplied meta-information and supplies the obtained meta-information to the meta-information recognizing unit 33.

In step S6, the meta-information recognizing unit 33 recognizes the supplied meta-information and supplies the contents of the recognition to the additional-image-information generating unit 35.

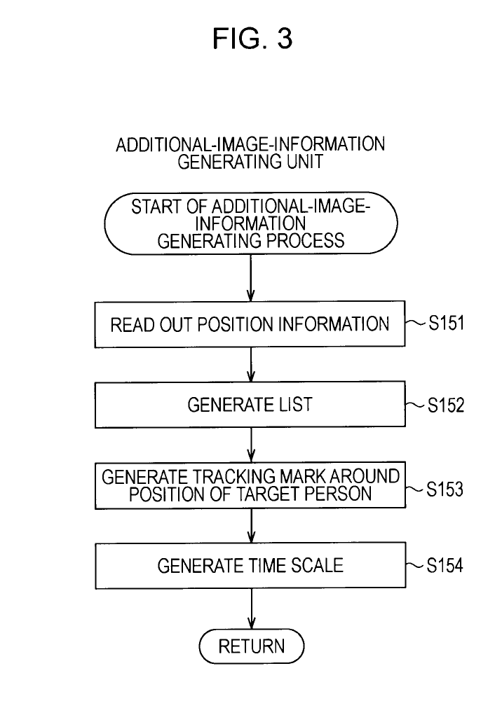

In step S7, the additional-image-information generating unit 35 generates additional image information by performing an additional-image-information generating process and supplies the additional image information to the additional-image-information output unit 34. Note that the additional-image-information generating process will be described in detail later with reference to the flowchart in FIG. 3.

In step S8, the additional-image-information output unit 34 outputs the additional image information generated by the additional-image-information generating unit 35 to the combining unit 13.

In step S101, the combining unit 13 combines a video stream containing images and the like including audio supplied from the stream playing unit 16 with an image constituting additional image information supplied from the additional-image-information providing unit 12, and, in step S102, displays the combined image on the display unit 2. Therefore, when the operation of the additional-image-information providing unit 12 is turned ON, an image constituting additional image information supplied from the additional-image-information providing unit 12 is combined with a video stream containing images including audio, and the combined image is displayed on the display unit 2. In contrast, when the operation of the additional-image-information providing unit 12 is not turned ON and remains turned OFF, a video stream containing images including audio supplied from the stream playing unit 16 is only simply displayed on the display unit 2.

In addition, in step S9, the meta-information-file-reading managing unit 31 determines whether or not the operation unit 11 has been operated and a request for stopping providing additional image information has been given, that is, whether or not a request for turning OFF the operation of the additional-image-information providing unit 12 has been given. For example, when no request for termination has been given, the process returns to step S4. That is, as long as no request for stopping providing additional image information is given, the processing in steps S4 through S9 is repeated. As a result, when it is determined that there has been no request for cancelling registration, the combining unit 13 combines an image constituting additional image information supplied from the additional-image-information providing unit 12 with a video stream containing images including audio supplied from the stream playing unit 16, and continuously displays the combined image on the display unit 2.

When, in step S9, for example, a request for stopping providing additional image information has been given, in step S10, the meta-information-file-reading managing unit 31 requests the stream-synchronized reading unit 15 to cancel registration of the meta-information-file reading unit 14.

In step S41, the stream-synchronized reading unit 15 determines whether or not a request for cancelling registration of the meta-information-file reading unit 14 has been given. When no request for cancelling registration has been given, the process returns to step S33. That is, the processing in steps S33 through S41 is repeated.

In contrast, when, in step S41, a request for cancelling registration of the meta-information-file reading unit 14 has been given by, for example, the processing in step S10, in step S42, the stream-synchronized reading unit 15 cancels registration of the meta-information-file reading unit 14 which has been requested to be cancelled. As a result, the stream-synchronized reading unit 15 enters a state in which the stream-synchronized reading unit 15 supplies no playback information to the meta-information-file reading unit 14.

In step S11, the meta-information-file-reading managing unit 31 discards the meta-information-file reading unit 14, and the process returns to step S1.

With the foregoing process, a video stream read out from the stream file 4 is combined with additional image information generated on the basis of meta-information recorded in the meta-information file 3. Simply by replacing only the meta-information file 3, additional image information can be changed. In addition, it is unnecessary to construct the stream file 4 in accordance with the type of additional image information. Only one stream file is required to be recorded. Therefore, the recording capacity can be saved.

Next, with reference to the flowchart in FIG. 3, the additional-image-information generating process will be described.

In step S151, the list generating unit 41 reads out position information of each player, which is meta-information obtained by the processing in step S5. Further, in step S152, the list generating unit 41 generates, on the basis of the read position information, a list of players participating in a soccer game played as a video stream.

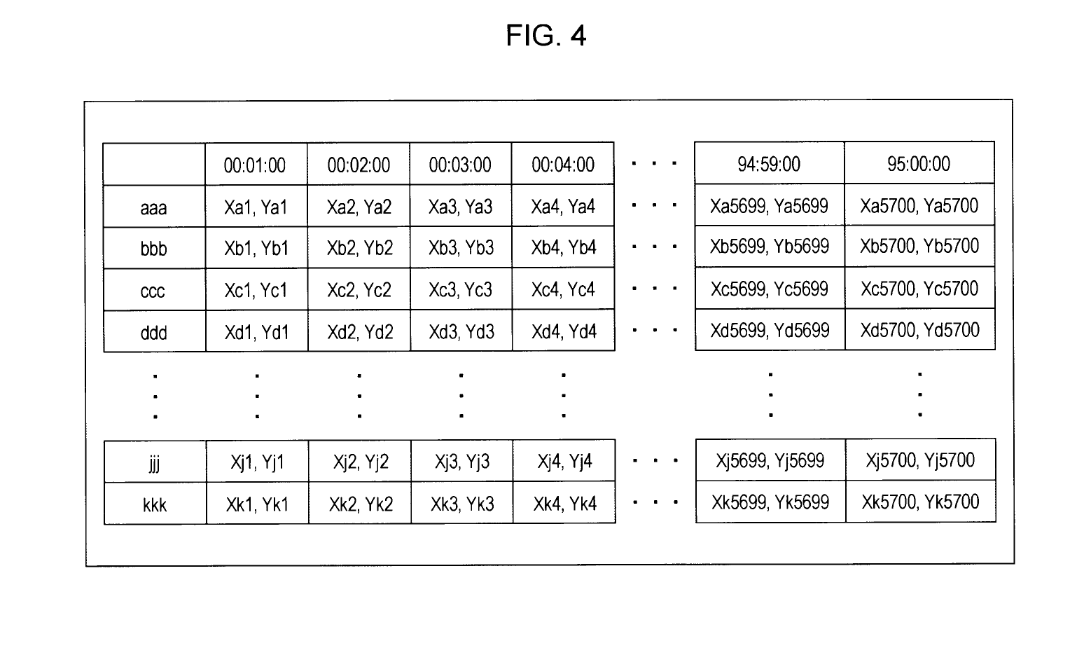

Here, the structure of the meta-information file 3 will be described. The meta-information file 3 is, for example, such as that shown in FIG. 4. In FIG. 4, items of position information of each player on the screen, which are given for individual elapsed times of a game, are sequentially displayed, starting with the left side. That is, in FIG. 4, it is shown that there are 11 players, “aaa”, “bbb”, “ccc”, “ddd”, . . . , “jjj”, and “kkk”. For example, the player “aaa” exists at the coordinates (Xa1, Ya1) on the screen at the time “00:01:00” (=“minutes:seconds:seconds/100), exists at the coordinates (Xa2, Ya2) on the screen at the time “00:02:00”, exists at the coordinates (Xa3, Ya3) on the screen at the time “00:03:00”, exists at the coordinates (Xa4, Ya4) on the screen at the time “00:04:00”, exists at the coordinates (Xa5699, Ya5699) on the screen at the time “94:59:00”, and exists at the coordinates (Xa5700, Ya5700) on the screen at the time “95:00:00”. Note that much the same is true on the players “bbb”, “ccc”, “ddd”, . . . , “jjj”, and “kkk”, and accordingly a description thereof is omitted.

From this, for example, in the case of the timing at the time “00:04:00”, the players' names “aaa”, “bbb”, “ccc”, “ddd”, . . . , “jjj”, and “kkk”, which are shown in FIG. 4, (Xa4, Ya4), (Xb4, Yb4), (Xc4, Yc4), (Xc4, Yc4), (Xd4, Yd4) . . . (Xj4, Yj4), which serve as positions at which the respective players exist, and the final time “95:00:00” are read out as meta-information from the meta-information file 3.

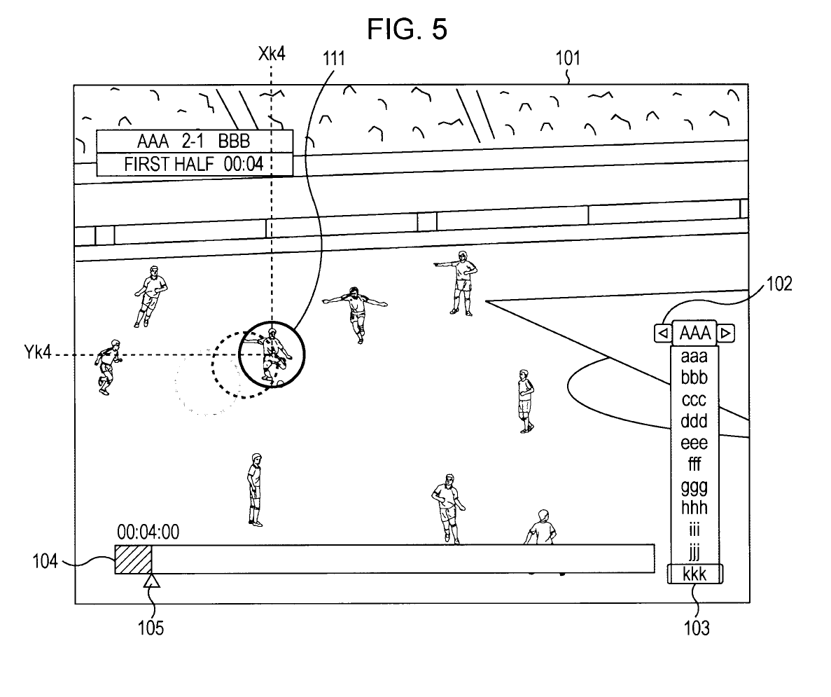

Therefore, on the basis of the meta-information, the list generating unit 41 generates a list 102 displayed in the lower right-hand corner of FIG. 5. In FIG. 5, an image of a soccer game being played by the stream playing unit 16 is displayed on an image display unit 101, and an image of the soccer game is displayed. In addition, starting from the top in the list 102 in FIG. 5, “aaa”, “bbb”, “ccc”, “ddd”, . . . “jjj”, and “kkk” are displayed. Further, a selecting frame 103 for selecting a player for which the user wishes to display a tracking mark 111 is displayed. The selecting frame 103 can be moved up and down using the operation unit 11. Accordingly, any of the players “aaa”, “bbb”, “ccc”, “ddd”, . . . “jjj”, and “kkk” can be selected. In FIG. 5, “kkk” is selected as a player for which the user wishes to display the tracking mark 111.

In step S153, the tracking-mark generating unit 42 generates the tracking mark 111 at the position of the selected player on the basis of the meta-information. That is, in FIG. 5, the selecting frame 103 is on “kkk”, and “kkk” is selected as a player for which the user wishes to display the tracking mark 111. Therefore, the tracking-mark generating unit 42 generates the tracking mark 111 around the coordinates (Xk4, Yk4) of “kkk” at the timing at the time “00:04:00”. Note that, although the tracking mark 111 is a circle in FIG. 5, needless to say, the tracking mark 111 can be of any other shape.

In step S154, the time-scale-bar generating unit 43 generates a time scale bar 104 on the basis of the supplied meta-information. That is, in FIG. 5, the time scale bar 104 is displayed in a lower portion of the image display unit 101. Further, on the time scale bar 104, a current mark 105 is displayed at a position indicating the proportion of the time “00:04:00” when the horizontal length is “95:00:00” in its entirety. Besides generating the time scale bar 104, the time-scale-bar generating unit 43 calculates and obtains the position indicating the proportion of the time “00:04:00” when the horizontal length is “95:00:00” in its entirety, adds the current mark 105 at that position, and generates an image of the time scale bar 104.

With the additional-image-information generating process, images of the list 102, the selecting frame 103, the tracking mark 111, the time scale bar 104, and the current mark 105 in FIG. 5 are generated at respective positions, and, with the processing in step S8 described above, are output to the combining unit 13. Then, with the processing in step S101, the combining unit 13 combines, on the video stream image of the soccer game which has been read out from the stream file 4 and displayed by the processing in step S61, images including these items of additional image information so as to be displayed in an overlapping manner, and displays the combined image on the display unit 2, thereby displaying an image such as that shown in FIG. 5.

As a result, when players in the list 102 are selected using the selecting frame 103, the tracking marks 111 are successively added to the selected players. The user can thus find the players selected in various scenes. Note that FIG. 5 shows the case in which it has been set so that the tracking mark 111 is displayed once and then the tracking mark 111 gradually becomes lighter over a predetermined time and finally disappears. As a result, the accumulative movement of a selected player is displayed as an afterimage of the tracking mark 111. Therefore, the user can more easily recognize the moving direction, whereby the user can view the movement of a selected player with closer attention. Note that a tracking mark displayed as an afterimage is shown by a dotted line in FIG. 5.

In addition, although the above description concerns the example in which additional image information that adds the tracking mark 111 to a selected player is provided, other additional image information may be provided using similar meta-information. For example, instead of adding the tracking mark 111, an image zoomed up by a predetermined factor may be displayed around the position of a selected player. By providing such additional image information, the user can continuously view an enlarged image of playing of a selected player on the display unit 2.

Further, the above description concerns the example where images including audio played on the basis of the stream file 4 are recorded images of a soccer game broadcast and a tracking mark is added as additional image information to a selected player. Alternatively, for example, when images including audio played on the basis of the stream file 4 represent a drama, a movie, or the like, a correlation chart of characters or the like may be displayed as additional image information.

FIG. 6 shows a structure example of the playing apparatus 1 configured to display a correlation chart of characters or the like as additional image information when images including audio played on the basis of the stream file 4 represent a drama, a movie, or the like. Note that, in the playing apparatus 1 in FIG. 6, the same reference numerals are given to the same structures as the structures in the playing apparatus 1 in FIG. 1, and descriptions thereof are appropriately omitted.

In the playing apparatus 1 in FIG. 6, structures different from the playing apparatus 1 in FIG. 1 are the fact that an additional-image-information generating unit 141 is provided in place of the additional-image-information generating unit 35, and the contents of the meta-information file 3.

The additional-image-information generating unit 141 includes a face-image-frame generating unit 151, a group-frame generating unit 152, a correlation generating unit 153, a time-scale-bar generating unit 154, and a cast-frame generating unit 155. The face-image-frame generating unit 151 generates a face image frame of a character on the basis of meta-information. The group-frame generating unit 152 generates an image of a group frame, which is generated by organizing face image frames into groups and displayed, on the basis of grouping information which is included in meta-information and is used to organize characters into groups. The correlation generating unit 153 generates an arrow-shaped correlation image indicating the relationship between characters. The time-scale-bar generating unit 154 generates, on the basis of meta-information, an image of a time scale bar indicating a playback position with respect to the total playback time of a drama or a movie read out and played from the stream file 4, and an event in a story. The cast-frame generating unit 155 generates an introductory image of a character on the basis of meta-information.

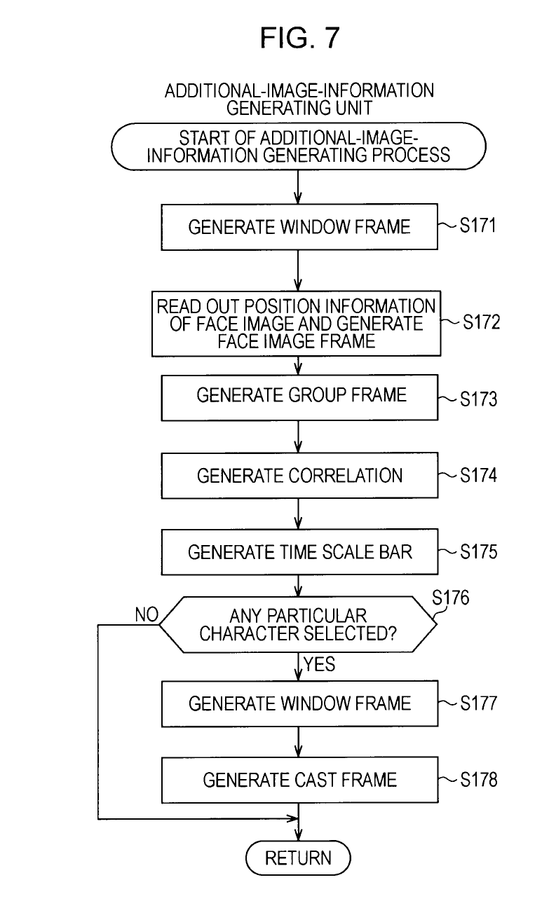

Next, with reference to the flowchart in FIG. 7, an additional-image-information generating process performed by the playing apparatus 1 in FIG. 6 will be described. Note that, since an additional-image-information providing process performed by the playing apparatus 1 in FIG. 6 is similar to the process described with reference to FIG. 2 except for the additional-image-information generating process in step S7, a description thereof is omitted.

In step S171, the additional-image-information generating unit 141 generates an image displaying a window 202 (FIG. 9) for displaying a correlation chart as additional image information.

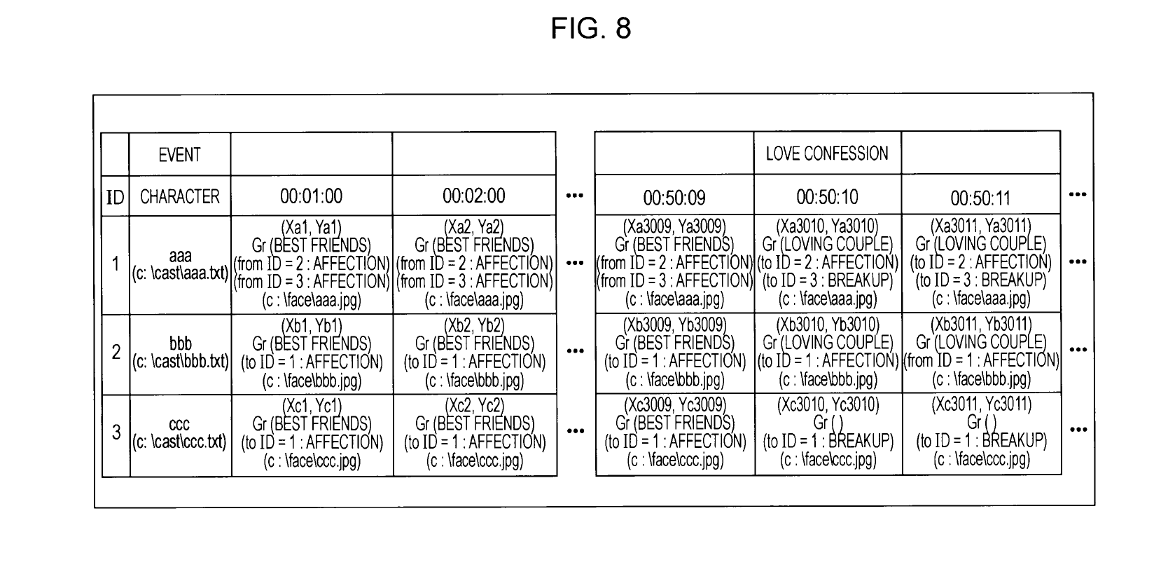

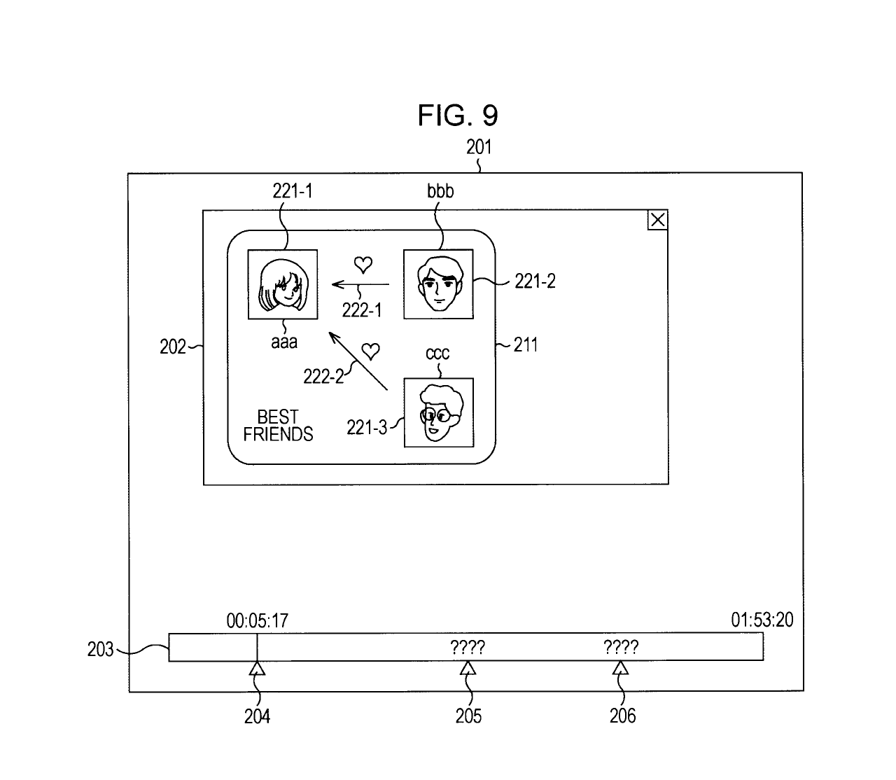

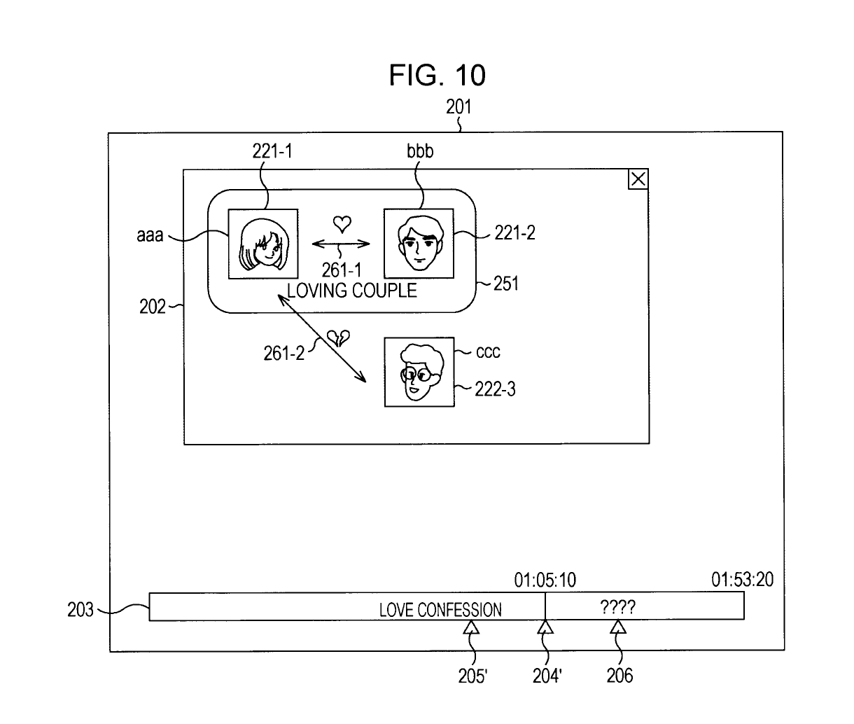

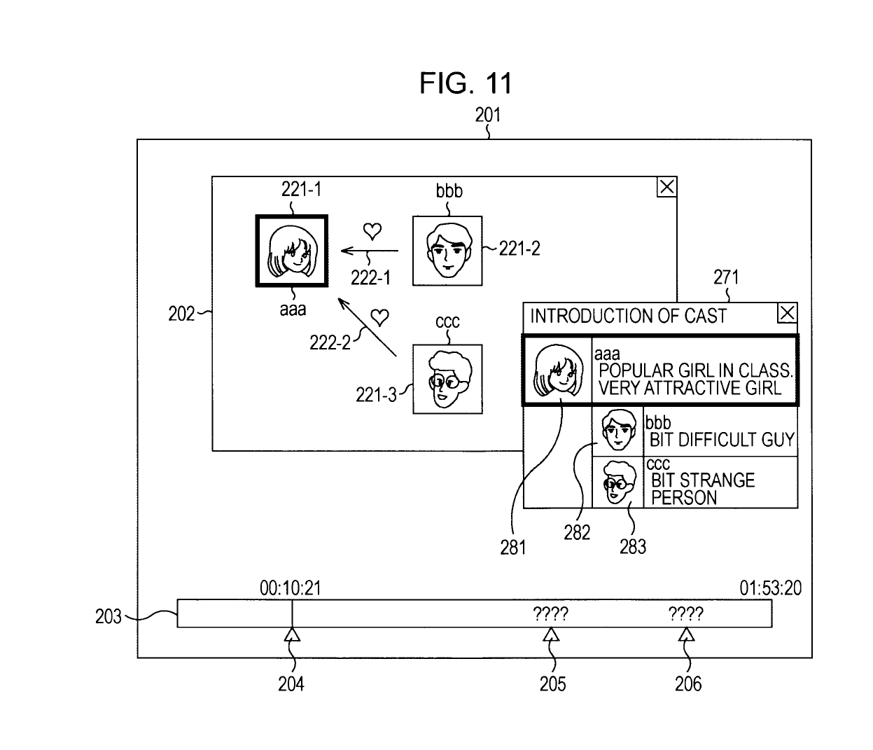

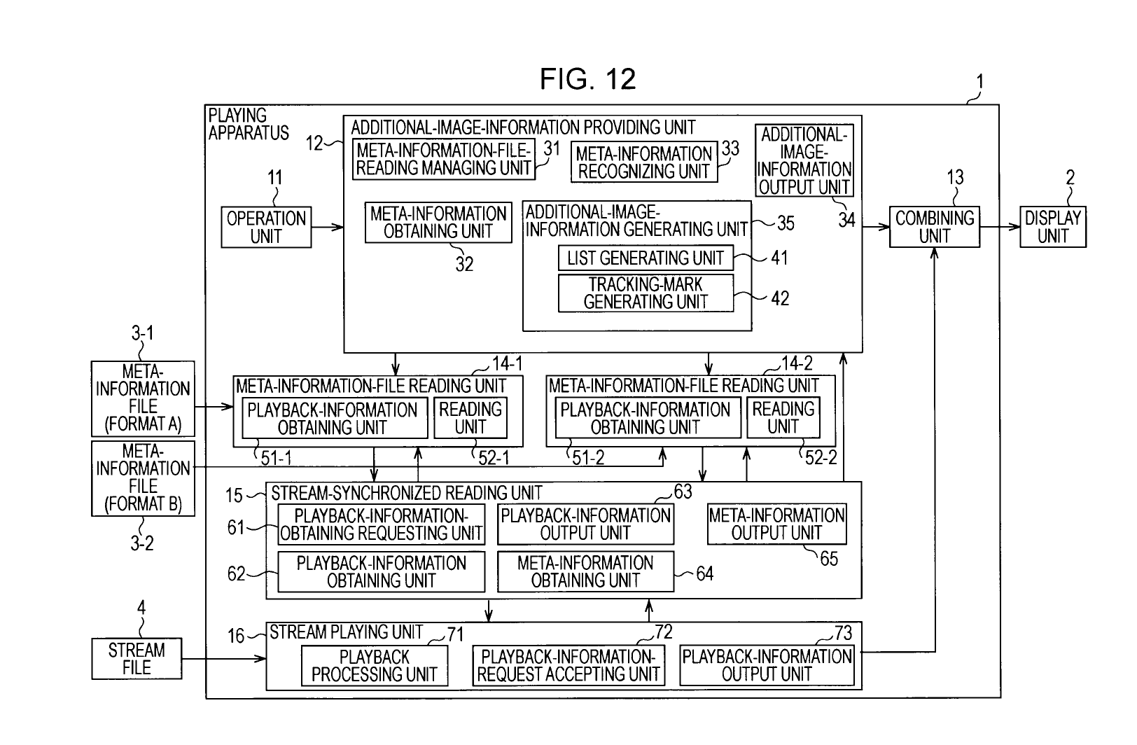

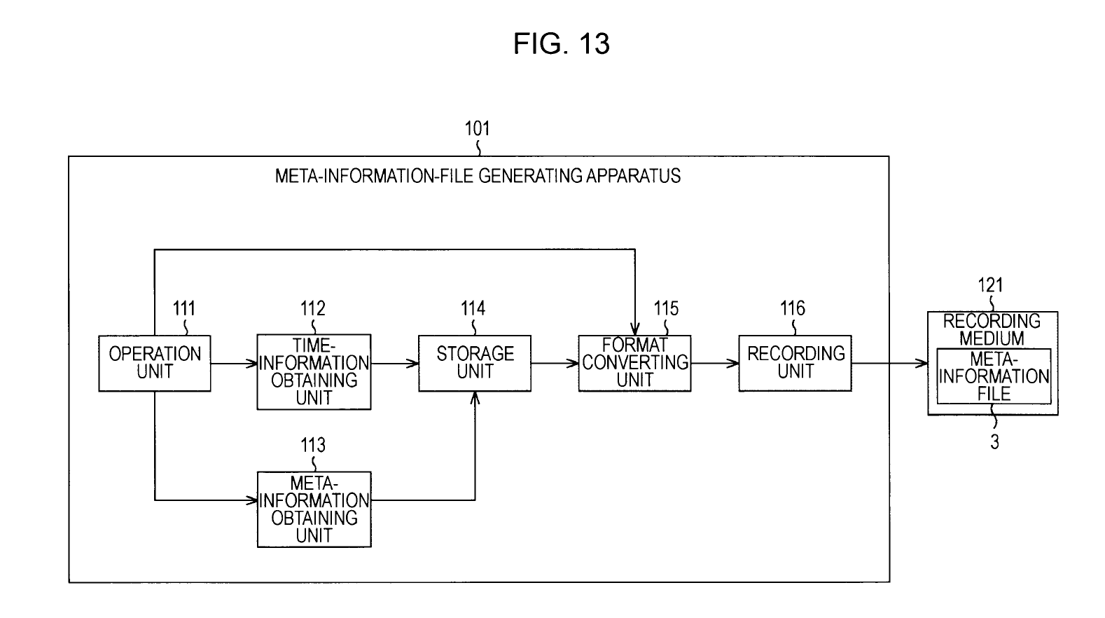

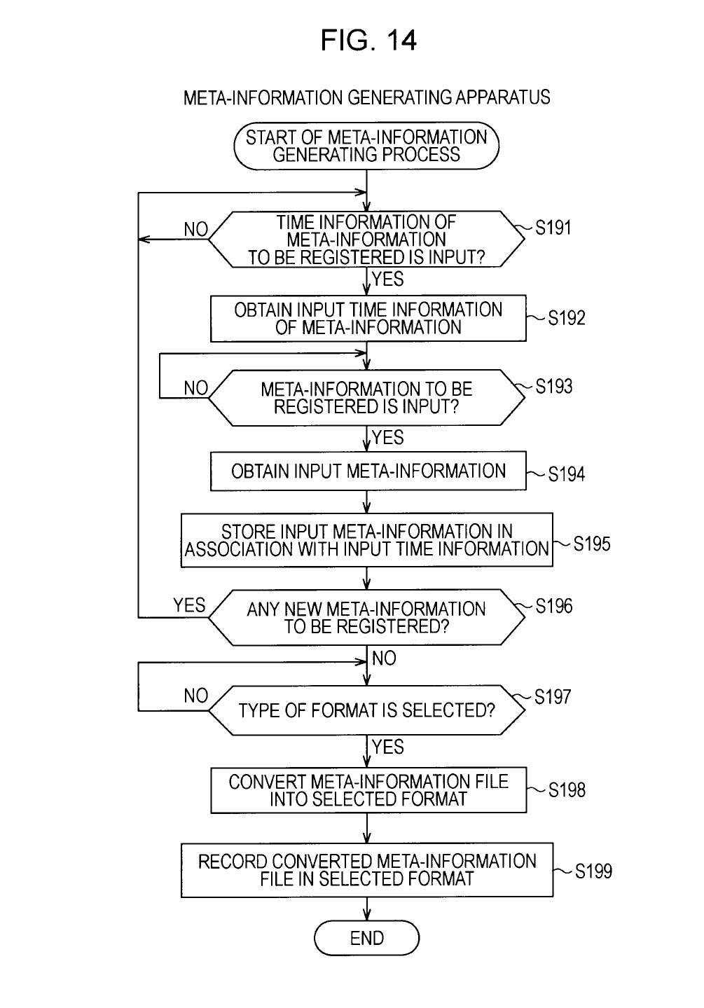

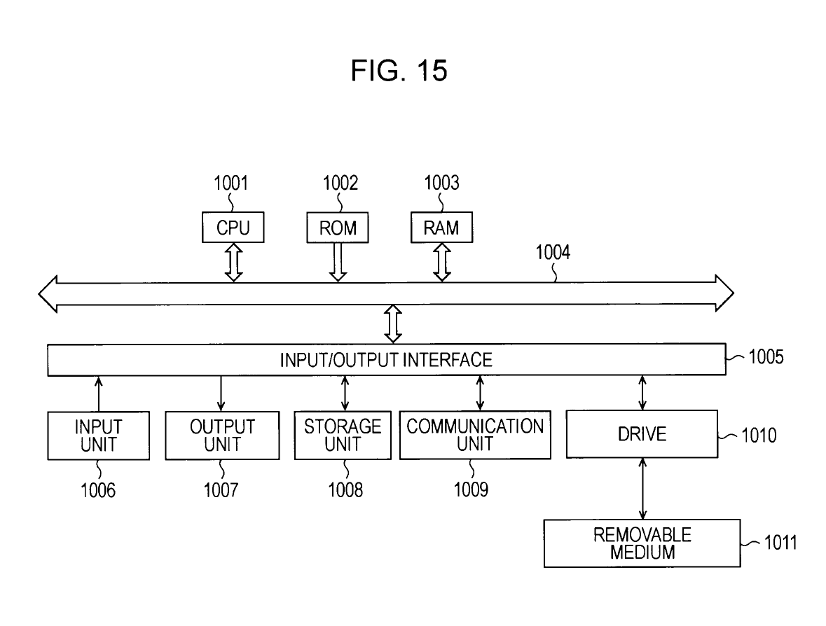

In step S172, the face-image-frame generating unit 151 reads out position information of a face image for each character on the basis of meta-information and generates a face image frame. That is, the meta-information file 3 in the playing apparatus 1 in FIG. 6 is such as that shown in FIG. 8. In FIG. 8, starting from the left, an ID, a character name, a display center position of a face image frame at each playback time, grouping information, correlation information, and a storage location of the face image, which are set for each character, are shown.

That is, in FIG. 8, regarding the character “aaa”, it is individually shown that the ID=1; introduction document data of the character is stored at “c:¥cast¥aaa.txt”; at the time “00:01:00” (=“hours:minutes:seconds”), the center position coordinates of a face image on the screen are the coordinates (Xa1, Ya1); grouping information Gr (best friends) indicates “best friends”; correlation information (from ID=2: affection) indicates that the character “bbb” with “ID=2” has affection for the character “aaa”; correlation information (from ID=3: affection) indicates that the character “ccc” with “ID=3” has affection for the character “aaa”; information of the face image of the character “aaa” is stored at “c:¥face¥aaa.jpg”.

In addition, regarding the character “aaa” with ID=1, it is individually shown that at the time “00:02:00”, the center position coordinates of the face image on the screen are the coordinates (Xa2, Ya2); grouping information Gr (best friends) indicates “best friends”; correlation information (from ID=2: affection) indicates that the character “bbb” with “ID=2” has affection for the character “aaa”; correlation information (from ID=3: affection) indicates that the character “ccc” with “ID=3” has affection for the character “aaa”; information of the face image of the character “aaa” is stored at “c:¥face¥aaa.jpg”.

Further, regarding the character “aaa” with ID=1, it is individually shown that at the time “00:50:09”, the center position coordinates of the face image on the screen are the coordinates (Xa3009, Ya3009); grouping information Gr (best friends) indicates “best friends”; correlation information (from ID=2: affection) indicates that the character “bbb” with “ID=2” has affection for the character “aaa”; correlation information (from ID=3: affection) indicates that the character “ccc” with “ID=3” has affection for the character “aaa”; information of the face image of the character “aaa” is stored at “c:¥face¥aaa.jpg”.

In addition, regarding the character “aaa” with ID=1, it is individually shown that at the time “00:50:10”, the center position coordinates of the face image on the screen are the coordinates (Xa3010, Ya3010); grouping information Gr (loving couple) indicates a “loving couple”; correlation information (to ID=2: affection) indicates that the character “aaa” has affection for the character “bbb” with “ID=2”; correlation information (from ID=3: breakup) indicates that the relationship of the character “aaa” with the character “ccc” with “ID=3” has “broken up”; and information of the face image of the character “aaa” is stored at “c:¥face¥aaa.jpg”. Further, at this timing, as indicated in the topmost row, “love confession” is registered as an important event in the story.

Further, regarding the character “aaa” with ID=1, it is individually shown that at the time “00:50:11”, the center position coordinates of the face image on the screen are the coordinates (Xa3011, Ya3011); grouping information Gr (loving couple) indicates a “loving couple”; correlation information (to ID=2: affection) indicates that the character “aaa” has affection for the character “bbb” with “ID=2”; correlation information (to ID=3: breakup) indicates that the relationship of the character “aaa” with the character “ccc” with “ID=3” has “broken up”; and information of the face image of the character “aaa” is stored at “c:¥face¥aaa.jpg”.

Note that, since the characters “bbb” and “ccc” with IDs=2 and 3 are similar to the character “aaa” with ID=1, descriptions thereof are omitted.

From the meta-information file 3 in FIG. 8, for example, in the case of the timing at the time “00:02:00”, regarding the individual characters “aaa”, “bbb”, and “ccc” with IDs=1 to 3 shown in FIG. 8, (Xa2, Ya2), (Xb2, Yb2), and (Xc2, Yc2) serving as face image display positions, Gr (best fiends), Gr (best friends), and Gr (best friends) serving as grouping information, correlation information (from ID=2: affection) and correlation information (from ID=3: affection) for “aaa”, and correlation information (to ID=1: affection) for each of “bbb” and “ccc”, which serve as correlation information, (c:¥face¥aaa.jpg), (c:¥face¥bbb.jpg), and (c:¥face¥ccc.jpg) serving as storage locations of respective face images, (c:¥cast¥aaa.txt), (c:¥cast¥bbb.txt), and (c:¥cast¥ccc.txt) serving as storage locations of respective items of introduction information, a total playback time, and “love confession” as an event at the time “00:50:10” are respectively read out as meta-information.

Therefore, on the basis of the meta-information, the face-image-frame generating unit 151 generates, as shown in FIG. 9, face image frames 221-1 to 221-3 for the characters “aaa”, “bbb”, and “ccc”, respectively, on the window 202 displaying additional image information. In FIG. 9, images of a drama or a movie being played by the stream playing unit 16 from the stream file 4 are displayed on an image display unit 201, and the window 202 indicating additional image information is displayed. Note that images of a drama or a movie displayed on the image display unit 201 are omitted in FIG. 9.

For example, at the time “00:02:00”, the face-image-frame generating unit 151 reads out face images of the characters “aaa”, “bbb”, and “ccc” from (c:¥face¥aaa.jpg), (c:¥face¥bbb.jpg), and (c:¥face¥ccc.jpg) and generates the face image frames 221-1 to 221-3 in FIG. 9 around the respective positions (Xa2,Ya2), (Xb2,Yb2), and (Xc2,Yc2) on the window 202.

In step S173, the group-frame generating unit 152 generates a group frame 211 on the basis of the meta-information. That is, for example, at the time “00:02:00”, each of the items of grouping information of the characters “aaa”, “bbb”, and “ccc” is Gr (best friends). The group frame 211 is generated enclosing the face image frames 221-1 to 221-3 having the same grouping information, and “best friends” is added as a group structure.

In step S174, the correlation generating unit 153 generates correlations 222-1 and 222-2 on the basis of the meta-information. That is, for example, at the time “00:02:00”, items of correlation information of the characters “aaa”, “bbb”, and “ccc” are correlation information (from ID=2: affection) and correlation information (from ID=3: affection) for “aaa”, and correlation information (to ID=1: affection) for each of “bbb” and “ccc”. In this display, correlation information is constructed as (the shape at the end point of an arrow originating from oneself ID=ID of the face image at the end position: relationship). For example, the shape at the end point of an arrow originating from oneself is either “from” or “to”. In the case of “from”, the shape at the end point of an arrow originating from oneself shows no arrow mark. In the case of “to”, the shape at the end point of an arrow originating from oneself shows an arrow mark.

That is, for example, in the case of correlation information (from ID=2: affection) for “aaa”, the correlation 222-1 which has a start point at the face image frame 221-1 and an end point at the face image frame 221-2 of “bbb” with ID=2 and shows no arrow mark is constructed. In contrast, for example, for “bbb”, in the case of correlation information (from ID=1: affection), the correlation 222-1 which has a start point at the face image frame 221-2 and an end point at the face image frame 221-1 with ID=1 and shows an arrow mark is constructed. As a result, on the basis of these two items of correlation information, the correlation 222-1 is constructed as an arrow shape in a direction from the face image frame 221-2 to the face image frame 221-1. Further, the correlation 222-1 is displayed with a heart mark provided therebelow in order to show “affection”.

In addition, for example, in the case of correlation information (from ID=3: affection) for “aaa”, the correlation 222-2 which has a start point at the face image frame 221-1 and an end point at the face image frame 221-3 of “ccc” with ID=3 and shows no arrow mark is constructed. In contrast, for example, for “ccc”, in the case of correlation information (from ID=1: affection), the correlation 222-2 which has a start point at the face image frame 221-3 and an end point at the face image frame 221-1 with ID=1 and shows an arrow mark is constructed. As a result, on the basis of these two items of correlation information, the correlation 222-2 is constructed as an arrow shape in a direction from the face image frame 221-3 to the face image frame 221-1. Further, the correlation 222-2 is displayed with a heart mark provided therebelow in order to show “affection”.

In step S175, the time-scale-bar generating unit 154 generates a time scale bar 203 on the basis of the supplied meta-information. That is, in FIG. 9, the time scale bar 203 is displayed in a lower portion of the image display unit 201. Further, on the time scale bar 203, a current mark 204 is displayed at a position indicating the proportion of the time “00:02:00” when the horizontal length is “01:53:20” in its entirety. Besides generating the time scale bar 203, the time-scale-bar generating unit 154 calculates and obtains the position indicating the proportion of the time “00:02:00” when the horizontal length is “01:53:20” in its entirety, adds the current mark 204 at that position, further calculates and obtains the positions each indicating the proportion of “love confession” as an event at the time “00:50:10” on the time scale bar 203, adds event marks 205 and 206 at the positions, and generates an image on the time scale bar 203.

Since the window 202 including such additional image information is displayed, as shown in FIG. 9, the correlation chart is displayed in which, although the characters “aaa”, “bbb”, and “ccc” are mutually best friends at the time “00:02:00”, each of the characters “bbb” and “ccc” has affection for the character “aaa”.

As a result, for example, as the video stream of a drama or a movie progresses, although similar correlations are maintained until the time “00:50:09”, when the person “bbb” says that the person “bbb” loves the person “aaa” at the time “00:50:10”, grouping information of the persons “aaa” and “bbb” changes. As indicated by Gr (loving couple), the persons “aaa” and “bbb” become a loving couple. As indicated by Gr( ) grouping information of the person “ccc” enters a state in which the person “ccc” belongs to none of the groups. In the case where correlation information for “aaa” is correlation information (to ID=2: affection) and correlation information (to ID:3 breakup), correlation information for “bbb” is correlation information (to ID=1: affection), and correlation information for “ccc” is correlation information (to ID=1: breakup), as shown in FIG. 10, the face image frames 221-1 and 221-2 of the characters “aaa” and “bbb” belonging to the same group, a loving couple, are enclosed within a group frame 251, and “loving couple” indicating the group is added.

Further, in the case of correlation information (from ID=2: affection) for “aaa”, a correlation 262-1 which has a start point at the face image frame 221-1 and an end point at the face image frame 221-2 of “bbb” with ID=2 and shows an arrow mark is constructed as a correlation. In contrast, for example, correlation information for “bbb” becomes correlation information (to ID=1: affection). Thus, the correlation 222-1 which has a start point at the face image frame 221-2 and an end point at the face image frame 221-1 with ID=1 and shows an arrow mark is constructed. As a result, on the basis of these two items of correlation information, a correlation 261-1 is constructed as an arrow shape in two directions between the face image frames 221-2 and 221-1. Further, the correlation 261-1 is displayed with a heart mark provided therebelow in order to show “affection”.

In addition, for example, in the case of correlation information (to ID=3: breakup) for “aaa”, a correlation 261-2 which has a start point at the face image frame 221-1 and an end point at the face image frame 221-3 of “ccc” with ID=3 and shows an arrow mark is constructed. In contrast, for “ccc”, in the case of correlation information (to ID=1: breakup), the correlation 261-2 which has a start point at the face image frame 221-3 and an end point at the face image frame 221-1 with ID=1 and shows an arrow mark is constructed. As a result, on the basis of these two items of correlation information, the correlation 261-2 is constructed as an arrow shape in two directions between the face image frames 221-3 and 221-1. Further, the correlation 261-2 is displayed with a broken heart mark provided therebelow in order to show a “break-up”.

Further, on the time scale bar 203, since the event “love confession” occurs at the time “00:50:10” at which the person “bbb” says that the person “bbb” loves the person “aaa”, as a new event mark 205′, the display is switched from “????” to “love confession”. Further, the current time “01:05:10” is displayed at a current mark 204′.

As a result, when the person “bbb” says that the person “bbb” loves the person “aaa” at the time “00:50:10”, as shown in FIG. 10, from the time “00:50:10” onward, the characters “aaa” and “bbb” become a loving couple, and the characters “ccc” and “aaa” change to a broken-up relationship. The fact that the best friendship has been broken is shown in the correlation chart.

In step S176, the additional-image-information generating unit 141 determines whether or not the operation unit 11 has been operated and a face image frame 221 of a specific character has been designated. For example, as shown in FIG. 11, when the face image frame 221-1 has been selected, in step S177, a window 271 that is for displaying a cast frame and is given the title “Introduction of Cast” is generated. In addition, for example, the selected face image frame 221-1 is changed to bold, whereby the selected face image frame 221 can be easily recognized.

In step S178, the cast-frame generating unit 155 displays a profile of each character on the window 271 on the basis of the meta-information. That is, the cast-frame generating unit 155 reads out face images from (c:¥face¥aaa.jpg), (c:¥face¥bbb.jpg), and (c:¥face¥ccc.jpg) which are storage locations of the face images, additionally accesses (c:¥cast¥aaa.txt), (c:¥cast¥bbb.txt), and (c:¥cast¥ccc.txt), respectively, which are storage locations of introduction information, to read out items of introduction information, and generates cast frames 281 to 283, respectively. In FIG. 11, since the cast frame 281 is for the selected character “aaa”, the cast frame 281 is larger than the other cast frames. Together with the face image, the profile “popular girl in class, very attractive girl” is written. In the cast frame 282, together with the face image of the character “bbb” who is not selected, the profile “bit difficult guy” is written. In the cast frame 283, together with the face image of the character “ccc” who is not selected, the profile “bit strange person” is written.

Note that, when it is determined in step S176 that no face image frame 221 of a specific character has been selected, the processing in steps S177 and S178 is skipped. Thus, the window 271 is not displayed.

With the foregoing process, the correlation chart of characters, which changes as a drama or a movie stored in the stream file 4 progresses, and introduction documents of the characters are illustrated and displayed.

As a result, the user can view a drama, a movie, or the like with many characters or complicated relationships while checking the correlation chart.

Although the above description concerns the case where there is one type of meta-information file 3, a plurality of meta-information files 3 may be used.

FIG. 12 shows a structure example of the playing apparatus 1 configured to provide additional image information added to images including audio played from the stream file 4 using meta-information files 3-1 and 3-2 having different formats. Since meta-information files are recorded in different formats, the meta-information files are set as files independent of each other. Note that, in the playing apparatus 1 in FIG. 12, the same reference numerals are given to the same structures as the structures in the playing apparatus 1 in FIG. 1, and descriptions thereof are omitted.

In the playing apparatus 1 in FIG. 12, a difference from the playing apparatus 1 in FIG. 1 resides in that meta-information-file reading units 14-1 and 14-2 are provided in place of the meta-information-file reading unit 14. The meta-information-file reading units 14-1 and 14-2 respectively include playback-information obtaining units 51-1 and 51-2, which are identical. A reading unit 52-1 reads out meta-information from the meta-information file 3-1 recorded in a format A, and a reading unit 52-2 reads out meta-information from the meta-information file 3-2 recorded in a format B. In this embodiment as above, meta-information files in different formats can be handled. The format A is an easy-to-edit file in a plain text format that is easy to recognize for human beings, and the format B is a compressed meta-information file. Therefore, meta-information files are used in such a manner that editing is further facilitated and the capacity of a recording medium is efficiently used.

However, items of meta-information read out by the reading units 52-1 and 52-2 are information in the same format. The items of meta-information read out by the reading units 52-1 and 52-2 are combined and supplied to the additional-image-information providing unit 12.

In addition, regarding the additional-image-information providing process, since steps S81 to S84, which are the processing performed by the meta-information-file reading unit 14 and described with reference to the flowchart in FIG. 2, are simply performed by each of the meta-information-file reading units 14-1 and 14-2 independent of each other, a description thereof is omitted.

Although the above description concerns the example in which the correlation between persons and profiles of characters are displayed as additional image information, for example, an interview of an actor acting a character may be displayed at the time of playing an associated scene.

According to the above, additional image information synchronized with the contents of playback of images, audio, and the like can be provided to content in a video stream containing images including various sounds.

In addition, since a stream file and a meta-information file are separate files, they can be edited separately. Without creating again a stream of images and audio of a main part, playback can be performed simply by adding new meta-information.

Further, the work of generating a video stream containing images and audio and the work of generating meta-information can be separated from each other and can be simultaneously performed in parallel to each other. Therefore, the total editing time can be reduced.

Also, addition or replacement of meta-information may be performed by using information obtaining means represented by downloading using a network. Even in the case of a packaged medium that has been sold, the viewer can be provided a new way of enjoying the packaged medium without buying a new packaged medium. Therefore, even after the viewer has purchased a packaged medium, the viewer can enjoy a function that could not have been enjoyed at the time of purchase by adding the function as additional image information.

Further, in the above playing apparatus 1, only the format of a meta-information file and a mechanism for reading in a meta-information file can be replaced. For example, for content in which the amount of information of a meta-information file is significantly large, a highly efficient compression-type format may be used in order to reduce the size of the meta-information file as much as possible. When a meta-information file is frequently edited by human beings, the meta-information file may be in a format that is easy to recognize for human beings. Accordingly, the format can be switched and used.

Next, with reference to FIG. 13, an embodiment of a meta-information-file generating apparatus that generates a meta-information file will be described.

A meta-information-file generating apparatus 101 in FIG. 13 generates the meta-information file 3 shown in FIG. 4 or FIG. 8.

An operation unit 111 is configured with a keyboard and an operation button and is operated to enter a playback time of a stream and meta-information at a corresponding playback time. The operation unit 111 supplies information of a playback time according to the contents of operation to a time-information obtaining unit 112 and supplies meta-information at a corresponding playback time to a meta-information obtaining unit 113. Also, when designating the format of the meta-information file 3 or when designating a mode that should be given a priority at the time of making a decision on the format of the meta-information file 3, the operation unit 111 is operated and supplies information according to the contents of the operation to a format converting unit 115.

The time-information obtaining unit 112 obtains information for specifying a playback time entered by operating the operation unit 111 and stores the information in a storage unit 114.

The meta-information obtaining unit 113 obtains meta-information entered by operating the operation unit 111 and stores the meta-information in the storage unit 114.

The storage unit 114 associates the information for specifying the playback time, which has been supplied from the time-information obtaining unit 112, and the meta-information supplied from the meta-information obtaining unit 113, and stores the associated information as the meta-information file 3.

The format converting unit 115 performs format conversion of the meta-information file 3 stored in the storage unit 114 into a format designated by the operation unit 111 or in accordance with the mode and supplies the converted meta-information file 3 to a recording unit 116. Note that the mode stated here indicates the priority of selecting which one of a plurality of format types that exist is to be selected. For example, when a mode that is easy to recognize for human beings is designated, the format converting unit 115 converts the meta-information file 3 into a format type which is, among a plurality of format types that exist, a format that is easy to recognize for human beings. When a mode in which the capacity is to be minimized is designated, the format converting unit 115 converts the meta-information file 3 into a highly efficient compression-type format that minimizes the capacity. When a mode suitable for processing performed by an information processing apparatus is designated, the format converting unit 115 converts the meta-information file 3 into a format type optical for processing performed by the information processing apparatus.

The recording unit 116 records the meta-information file 3 which has been formatted in a predetermined format and supplied from the format converting unit 115 in a recording medium 121. On this occasion, after executing format conversion corresponding to the recording format of the recording medium 121, the recording unit 116 records the meta-information file 3 in the recording medium 121.

Next, with reference to the flowchart in FIG. 14, a meta-information-file generating process performed by the meta-information-file generating apparatus 101 in FIG. 13 will be described.

In step S191, the time-information obtaining unit 112 determines whether or not the operation unit 111 has been operated and information of a playback time of a video stream, which corresponds to meta-information to be registered in the meta-information file 3, has been entered. The time-information obtaining unit 112 repeats similar processing until it is determined that the information is entered.

When it is determined in step S191 that, as information of a playback time, such as “00:01:00” or “00:50:10”, information of a playback time of a video stream has been entered, in step S192, the information of the playback time entered from the operation unit 111 is obtained and supplied to the storage unit 114.

In step S193, the meta-information obtaining unit 113 determines whether or not the operation unit 111 has been operated and meta-information has been entered. The meta-information obtaining unit 113 repeats similar processing until it is determined that the meta-information is entered.

In step S193, for example, when position information of each player is to be displayed in a video stream of a soccer game, as shown in FIG. 4, if it is determined that position information such as the coordinates (Xa1, Ya1) of each player on the screen of the game is entered as meta-information, or, when a correlation chart of characters or the like is to be displayed as additional image information of a drama, a movie, or the like, as shown in FIG. 8, if it is determined that coordinates (Xa1, Ya1), grouping information Gr (best friends), correlation information (from ID=2: affection), (from ID=3: affection), and information of the face image of the character “aaa” “c:¥face¥aaa.jpg” are entered as meta-information, in step S194, the meta-information entered from the operation unit 111 is obtained and supplied to the storage unit 114. Note that, when an event that switches display of a correlation chart of characters or the like serving as additional image information of a drama, a movie, or the like is entered, for example, as shown in FIG. 8, information of the event, such as “love confession”, may be entered as meta-information.

In step S195, the storage unit 114 associates the information of the playback time, which has been supplied from the time-information obtaining unit 112, and the meta-information supplied from the meta-information obtaining unit 113 and stores the associated information as the meta-information file 4, such as that shown in FIG. 4 or FIG. 8.

In step S196, the time-information obtaining unit 112 determines whether or not new meta-information exists at another playback time to be registered in the meta-information file 3 in accordance with the contents of operation of the operation unit 111. When it is determined that new meta-information exists at another playback time, the process returns to step S191. That is, the processing in steps S191 to S196 is repeated until the process enters a state in which there exists no new meta-information to be registered.

Then, when there exists no new meta-information to be registered in step S196, in step S197, the format converting unit 115 determines whether or not the operation unit 111 has been operated and the format type for converting the meta-information file has been selected, or whether or not a mode for selecting the format type has been entered. The format converting unit 115 repeats similar processing until the format type for converting the meta-information file has been selected or the mode for selecting the format has been entered.

When, for example, the format type has been selected or the mode for selecting the format type has been determined in step S197, in step S198, the format converting unit 115 performs format conversion of the meta-information file 3 stored in the storage unit 114 into the selected format type or the format type that should be selected according to the mode, and supplies the converted meta-information file 3 to the recording unit 116.

In step S199, the recording unit 116 records the format-converted meta-information file 3, which has been supplied from the format converting unit 115, as a separate file independent of a stream file and records the meta-information file 3 in the recording medium 121 in a predetermined format.

With the foregoing process, the meta-information file 3 which has been converted into a specified file format type is generated. Since the meta-information file 3 is generated as a file independent of the stream file 4 in such a manner, at the time of editing only the meta-information, only the meta-information file 3 generated in the above-described manner is edited. Thus, the meta-information file 3 can be edited independently of the stream file 4. In addition, since it has been made possible to provide the meta-information file 3 and the stream file 4 independent of each other, for example, even when the meta-information files 3 corresponding to a plurality of languages are necessary, it is unnecessary to superfluously record the stream files 4 in a recording medium. Thus, the recording capacity can be kept to the minimum required amount. Further, when the user wishes to edit only the meta-information, since only the meta-information file 3 can be edited, editing of the meta-information can be facilitated. In addition, since a meta-information file has been set independently of a stream file, only the metadata file can be replaced by file replacement (Name mapping), and the latest information can be displayed. Accordingly, for example, when an actor in a movie recorded in a recording medium has won a certain prize, in order to display a history of prizes won by that actor, for example, a process of causing a playing apparatus to obtain new metadata via a network or the like and displaying the history of prizes at a section where that actor is appearing becomes also possible.

Now, the above-described series of image processes can be executed by hardware or executed by software. When the series of processes is to be executed by software, a program configuring the software is installed from a recording medium into a computer embedded in dedicated hardware, a general personal computer, for example, which can execute various functions using various programs being installed therein, or the like.

FIG. 15 shows a structure example of a general personal computer. This personal computer contains a CPU (Central Processing Unit) 1001. An input/output interface 1005 is connected to the CPU 1001 via a bus 1004. A ROM (Read Only Memory) 1002 and a RAM (Random Access Memory) 1003 are connected to the bus 1004.

An input unit 1006 including input devices such as a keyboard and a mouse that enter operation commands by the user, an output unit 1007 that outputs a processing operation screen and an image of a processing result to a display device, a storage unit 1008 including a hard disk drive or the like that stores programs and various items of data, and a communication unit 1009 that includes a LAN (Local Area Network) adapter or the like and executes communication processing via a network represented by the Internet are connected to the input/output interface 1005. In addition, a drive 1010 that reads/writes data from/to a removable medium 1011 such as a magnetic disc (including a flexible disc), an optical disc (including a CD-ROM (Compact Disc-Read Only Memory) and a DVD (Digital Versatile Disc)), a magneto-optical disc (including an MD (Mini Disc)), or a semiconductor memory is connected to the input/output interface 1005.

The CPU 1001 executes various processes in accordance with a program stored in the ROM 1002 or a program read out from the removable medium 1011, such as a magnetic disc, an optical disc, a magneto-optical disc, or a semiconductor memory, installed into the storage unit 1008, and loaded from the storage unit 1008 into the RAM 1003. In addition, data necessary for the CPU 1001 to execute various processes is stored, as necessary, in the RAM 1003.

Note that, in this specification, the steps describing the program recorded in the recording medium may of course include processes performed time sequentially in accordance with the described order, but also include processes executed not necessarily time sequentially but in parallel or individually.

1. A playing apparatus comprising:
stream playing means for playing an input video stream;
meta-information reading means for reading in meta-information of the video stream, the meta-information being a separate file from the video stream played by the stream playing means;
stream-synchronized reading means for controlling the meta-information reading means to read in the meta-information in synchronization with the video stream being played by the stream playing means on the basis of playback information of the video stream played by the stream playing means;
additional-image-information providing means for providing additional image information to the video stream on the basis of the meta-information read by the meta-information reading means under control of the stream-synchronized reading means; and
combining means for combining the additional image information provided by the additional-image-information providing means with the video stream played by the playing means.

2. The playing apparatus according to claim 1, further comprising:
output means for outputting the video stream combined with the additional image information, the combining being performed by the combining means,
wherein the meta-information is position information on a display screen at the time the video stream combined with the additional image information and output from the output means is displayed.

3. The playing apparatus according to claim 1,
wherein the meta-information
includes first meta information including first time information and second meta-information including second time information, and
wherein the stream-synchronized reading means
selects the first meta-information or the second meta-information by comparing a playback time of the video stream with the first time information or the second time information.

4. The playing apparatus according to claim 1,
wherein the meta-information reading means includes one or more meta-information reading means in accordance with a format.

5. The playing apparatus according to claim 1, further comprising:
obtaining means for obtaining the meta-information via a network,
wherein the stream-synchronized reading means reads in the meta-information obtained by the obtaining unit.

6. The playing apparatus according to claim 1,
wherein the meta-information is correlation information corresponding to playback information of each character in a case where the video stream is a drama or a movie, and
wherein the additional-image-information providing means provides, on the basis of the correlation information corresponding to the playback information of each character, a correlation chart of the characters as additional image information in synchronization with the playback information of the video stream played by the playing means.

7. The playing apparatus according to claim 1,
wherein, in a case where the video stream is a drama or a movie, the meta-information is correlation information corresponding to playback information of each character and additionally introduction information of the character, and
wherein the additional-image-information providing means provides, on the basis of the introduction information of each character, the introduction information of the character as additional image information in synchronization with the playback information of the stream played by the playing means.

8. A playing method comprising:
a stream playing step of playing an input video stream;
a meta-information reading step of reading in meta-information of the video stream, the meta-information being a separate file from the video stream played by processing in the stream playing step;
a stream-synchronized reading step of controlling the meta-information reading means to read in the meta-information in synchronization with the video stream being played by processing in the stream playing step on the basis of playback information of the video stream played by processing in the stream playing step;
an additional-image-information providing step of providing additional image information to the video stream on the basis of the meta-information read by processing in the meta-information reading step under control of processing in the stream-synchronized reading step; and
a combining step of combining the additional image information provided by processing in the additional-image-information providing step with the video stream played by processing in the playing step.

9. A program for causing a computer to execute a process comprising:
a stream playing step of playing an input video stream;
a meta-information reading step of reading in meta-information of the video stream, the meta-information being a separate file from the video stream played by processing in the stream playing step;
a stream-synchronized reading step of controlling the meta-information reading means to read in the meta-information in synchronization with the video stream being played by processing in the stream playing step on the basis of playback information of the video stream played by processing in the stream playing step;
an additional-image-information providing step of providing additional image information to the video stream on the basis of the meta-information read by processing in the meta-information reading step under control of processing in the stream-synchronized reading step; and
a combining step of combining the additional image information provided by processing in the additional-image-information providing step with the video stream played by processing in the playing step.

10. A program storage medium storing the program according to claim 9.

11. A data storage medium storing a video stream including time information at which playback should be performed by a playing apparatus,
wherein the data storage medium stores, as separate files from the video stream,
first meta-information corresponding to the video stream displayed at a first time position, the first meta-information including time information corresponding to the first time position, the first time position being included in a time axis of the time information, and
second meta-information corresponding to the video stream displayed at a second time position, the second meta-information including time information corresponding to the second time position, the second time position being included in the time axis of the time information.

12. A data structure of a meta-information file to be played together with a video stream including time information at which playback should be performed by a playing apparatus, the meta-information file being recorded in a recording medium or distributed via a network, the data structure comprising:
first meta-information corresponding to the video stream displayed at a first time position, the first meta-information including time information corresponding to the first time position, the first time position being included in a time axis of the time information; and
second meta-information corresponding to the video stream displayed at a second time position, the second meta-information including time information corresponding to the second time position, the second time position being included in the time axis of the time information.

13. The data structure according to claim 12,
wherein the first meta-information and the second meta-information are separate files independent of each other.

14. An information generating apparatus comprising:
time-information obtaining means for obtaining time information corresponding to a time position, the time position being included in a time axis of the time information of a video stream including the time information at which playback should be performed by a playing apparatus;
meta-information obtaining means for obtaining meta-information corresponding to the displayed video stream; and
storage means for associating at least one item of the time information with the meta-information and storing the associated information as a meta-information file.

15. The information generating apparatus according to claim 14, further comprising:
converting means for converting a format type of the meta-information file.

16. An information generating method comprising:
a time-information obtaining step of obtaining time information corresponding to a time position, the time position being included in a time axis of the time information of a video stream including the time information at which playback should be performed by a playing apparatus;
a meta-information obtaining step of obtaining meta-information corresponding to the displayed video stream; and
a storage step of associating at least one item of the time information with the meta-information and storing the associated information as a meta-information file.

17. A program for causing a computer to execute a process comprising:
a time-information obtaining step of obtaining time information corresponding to a time position, the time position being included in a time axis of the time information of a video stream including the time information at which playback should be performed by a playing apparatus;
a meta-information obtaining step of obtaining meta-information corresponding to the displayed video stream; and
a storage step of associating at least one item of the time information with the meta-information and storing the associated information as a meta-information file.

18. A program storage medium storing the program according to claim 17.
